(19) United States
(12) Patent Application Publication
(10) Pub. No.: US 2023/0025581 A1
(43) Pub. Date: Jan. 26, 2023

(54) Cable Guide and Storage Unit for a Cable Guide

(71) Applicant: igus GmbH, Köln (DE)

(72) Inventors: Jörg Dommnik, Neunkirchen-Seelscheid (DE); Simon Moritz, Köln (DE)

(21) Appl. No.: 17/786,898

(22) PCT Filed: Dec. 18, 2020
(86) PCT No.: PCT/EP2020/087095

§ 371 Date: Sep. 20, 2022

(30) Foreign Application Priority Data
Dec. 19, 2019 (DE) 20 2019 107 118.4

(51) Int. Cl. F16G 13/16; H02G 3/04; H02G 11/00

(52) U.S. Cl. CPC F16G 13/16; H02G 3/04; H02G 11/006

(57) ABSTRACT

At least one first section of a cable guide for receiving energy or communication cables in a receiving area can be arranged in the form of a first and second strand (3, 4), which are connected together by a deflecting region (2) extending about a deflecting arc, wherein the cable guide can be moved about the deflecting arc of the deflecting region (2). The aim of the invention is to allow a movement of the cable guide about the deflecting arc in the most frictionless manner possible while keeping the deflecting region stable. This is achieved in that a stabilization element (5) is provided which is substantially adapted to the deflecting arc and is arranged in a deflecting region (2) guide area that extends along the first section of the cable guide and passes through said section at least in one region and which supports the deflecting region (2) in the guide area in a floating manner when the cable guide is being moved about the deflecting arc without emerging from the guide area.

The invention relates to a cable guide, for receiving energy or communication cables in a receiving space, which is arranged at least in a first portion in the form of two first and second strands connected to one another by a deflection region extending about a deflection arc, wherein the cable guide can be moved about the deflection arc of the deflection region.

The object of the present invention is to provide a cable guide of the type named above which makes it possible to move the cable guide as frictionlessly as possible about the deflection arc of the deflection region while keeping the deflection region stable.

The object is achieved according to the invention in that a stabilization element, which is substantially adapted to the deflection arc of the deflection region, is arranged in a guide space of the deflection region extending along the first portion of the cable guide and passing through it in at least one region, which stabilization element, during movement of the cable guide about the deflection arc, supports the deflection region in a floating manner in the guide space without emerging from it.

Because of the floating arrangement of the stabilization element in the guide space extending along the cable guide in the deflection region, it can be kept stable during movement of the cable guide, wherein only minimal friction forces arise between the deflection region and the stabilization element.

The floating arrangement of the stabilization element can be formed by a clearance—albeit a small clearance—between the stabilization element adapted to the deflection arc of the deflection region and the inner wall surfaces of the guide space receiving the stabilization element and extending along the cable guide.

The stabilization element preferably extends in the guide space along the respective deflection region.

The stabilization element can extend over the deflection region also partially into a region of the guide space of the first and/or second strand adjoining the deflection region.

The guide space for the stabilization element can be a partial region, extending along the cable guide, of the receiving space for the cables.

In a preferred embodiment, the stabilization element is formed as an arc-shaped bar adapted to the deflection arc of the deflection region.

The arc-shaped bar can be formed disc-shaped with a relatively small extent perpendicular to a plane in which the deflection arc of the deflection region runs and a relatively large extent along its arc-shaped progression in this plane.

The arc-shaped bar extends preferably along its larger extent in the guide space with a relatively small clearance.

The cable guide can be formed, at least in the first portion, as an energy chain, which has chain links adjoining one another pivotably in the longitudinal direction, wherein the chain links comprise in each case two side parts, which lie opposite one another in a transverse direction relative to the longitudinal direction and have narrow surfaces facing perpendicularly to the transverse direction and to the longitudinal direction and facing inwards and outwards in the deflection region, wherein at least some of the chain links have cross members connecting their side parts.

The cross members can be connected to the side parts in the region of the narrow surfaces.

In this embodiment of the cable guide, the receiving space for the cables extends between the side parts and the cross members. When the stabilization element is arranged in the receiving space, it can be arranged, in particular in the form of an arc-shaped bar, adjacent to the inner face of the side parts linked together on one side of the energy chain.

The side parts on one side are preferably detachable from and re-attachable to the cross members in the region of a possible position of the deflection region of the energy chain for the lateral insertion of the stabilization elements.

Alternatively, it can also be provided that the cross members arranged in the region of a possible position of the deflection region of the energy chain, in particular the cross members facing outwards in relation to the deflection region, are detachable from the side parts connected thereby or can be folded back.

Furthermore, the energy chain can be formed such that adjacent chain links are capable of being angled in one pivoting direction to a limited degree relative to one another due to limit stops and thereby define a minimum radius for the deflection arc of the deflection region of the energy chain. In the other pivoting direction, adjacent chain links are capable of being angled to a limited degree up to their orientation stretched out relative to one another. Since adjacent chain links in this case are not pivotable beyond their orientation stretched out relative to one another, in the case of substantially self-supporting strands in particular a relatively stable straight extension thereof is made possible.

The cable guide according to the invention can have several portions in the manner of the first portion, wherein in the deflection region of each portion a substantially rigid stabilization element, which is adapted to the deflection arc of the deflection region, is arranged in a guide space of the deflection region extending along the portion and passing through it in at least one region, which stabilization element, during movement of the cable guide about the deflection arc, supports the deflection region in a floating manner in the guide space without emerging from it. The stabilization element and the formation of the several portions of the cable guide can furthermore be configured as described above.

At least some of the portions formed in the manner of the first portion can be connected to one another and have a continuous receiving space for the cables and a continuous guide space for the stabilization elements arranged in a floating manner in the deflection regions.

The cable guide can be formed, for example, in the form of a continuous loop with two deflection regions lying opposite one another or can have several continuous loops arranged inside one another with in each case two deflection regions lying opposite one another. The axes of the deflection arcs of the deflection regions lying opposite one another in each case can be arranged with a spacing from one another. In the case of several continuous loops arranged inside one another, the deflection arcs of the deflection regions can have two axes, which are arranged with a spacing from one another and about which the deflection regions in question are arranged concentrically.

On the other hand, the cable guide can be arranged wound in the shape of a spiral with two winding axes spaced apart from one another, wherein the deflection arcs of the deflection regions of the cable guide extend about the winding axes. The spacing between the winding axes can be variable when the cable guide is moved.

The invention furthermore relates to a storage unit for a cable guide which comprises a storage housing and a cable guide, which can be arranged therein and is wound in the shape of a spiral, with the features described above, wherein the spiral has two winding axes arranged with a spacing from one another. The cable guide has a fixed connection point arranged stationarily in the storage housing in the interior of the spiral at one of its ends and a movable connection point at its other end, wherein, by movement of the movable connection point and movement caused thereby of the cable guide, the spacing of the winding axes from one another is variable between a minimum spacing and a maximum spacing.

Such a storage unit is suitable in particular for available storage spaces with a relatively long extension for a cable guide, wherein the maximum spacing between the winding axes of the spirally wound cable guide can be chosen to be relatively large and the cable guide can extend over relatively long strands in its maximally retracted state in the storage housing.

In a preferred embodiment of the storage unit, the fixed connection point is arranged in the central region of the storage housing relative to the extension of the storage housing in the longitudinal direction.

According to an alternative embodiment, the fixed connection point can be held stationary by a support of the deflection regions extending about one of the two winding axes, in particular of the deflection regions the outer faces of which in the storage housing face in the direction of the movable connection point. In this case the fixed connection point is to be transferred to the region of the stationary deflection regions or of the stationary winding axis about which these deflection regions extend vis-à-vis the embodiment example considered above. In this case, the maximally stored length of the cable guide can be extended compared with the above-described embodiment example by approximately half of the maximum spacing between the winding axes. When the cable guide is completely pulled out of the storage housing, a portion of the cable guide to the movable connection point which is longer by approximately half of the maximum spacing is thus also available. However, this alternative embodiment has the disadvantage that, due to the support of the stationary deflection arcs of the deflection regions extending about the stationary winding axis, friction losses arise and the strands cannot be supported in the central region of the storage housing, as described below.

Because of the stabilization elements of the spirally wound cable guide which are arranged in the deflection regions, it can be pulled out of the storage housing with relatively little tensile force on the strand connected to the movable connection point and can be inserted in the storage housing with relatively little compressive force on the strand connected to the movable connection point in its longitudinal direction. Due to the stabilization elements according to the invention arranged in the deflection regions, only slight friction forces arise in the deflection regions extending about the winding axes when the cable guide is pulled out of and inserted in the storage housing. The tensile and compressive force can, where appropriate, be exerted manually on the strand connected to the movable connection point and extending out of the storage housing.

The above-described storage unit according to the invention requires no pretensioning of the winding axes and thus of the deflection regions into a position in which the winding axes reach their maximum spacing. Such a pretensioning would in turn necessitate a support of the deflection regions of the cable guide extending about the winding axes, which would be associated with friction losses.

At least some of the stabilization elements arranged in the deflection regions lying opposite one another can be formed such that in the case of contraction of the portion of the energy chain located in the storage housing when the energy chain is pulled or moved out of the storage housing, they come into contact with their free ends in a finally reached position and thus define the minimum spacing of the winding axes.

The storage housing can have two parallel side plates, which are arranged parallel to the deflection arcs of the deflection regions of the cable guide and guide the deflection regions and strands of the cable guide laterally in a sliding manner with a small clearance, wherein the side plates extend in the longitudinal direction of the strands over the deflection regions of the cable guide on both winding axes. The movable connection point can be arranged outside the storage housing.

In the central region of the longitudinal extension of the side plates, guide projections can be provided on their inwardly facing surfaces to support and guide the strands of the cable guide in the storage housing.

Adjoining the region of the fixed connection point, an opening can be provided, at least in one side plate of the storage housing, for feeding the cables emerging from the cable guide in the case of the fixed connection point through.

At the face-side ends of the side plates the storage housing can have face plates and upper and lower closing plates connecting these to one another.

The upper and lower closing plate can be arranged such that they guide the upper or lower strand of the cable guide arranged in the storage housing in a sliding manner.

The storage housing can be formed of two housing shells, the separation face of which lies in a plane which extends parallel to the deflection arcs of the deflection regions of the cable guide.

In the upper or lower region one of the face plates can have a feed-through opening for the strand of the cable guide connected to the movable connection point.

Embodiment examples of the present invention are described in more detail below with reference to the drawing.

In the drawing there are shown in:

FIG. 1 a side view of a first portion of an energy chain,

FIG. 2 a plan view of the portion of the energy chain shown in FIG. 1,

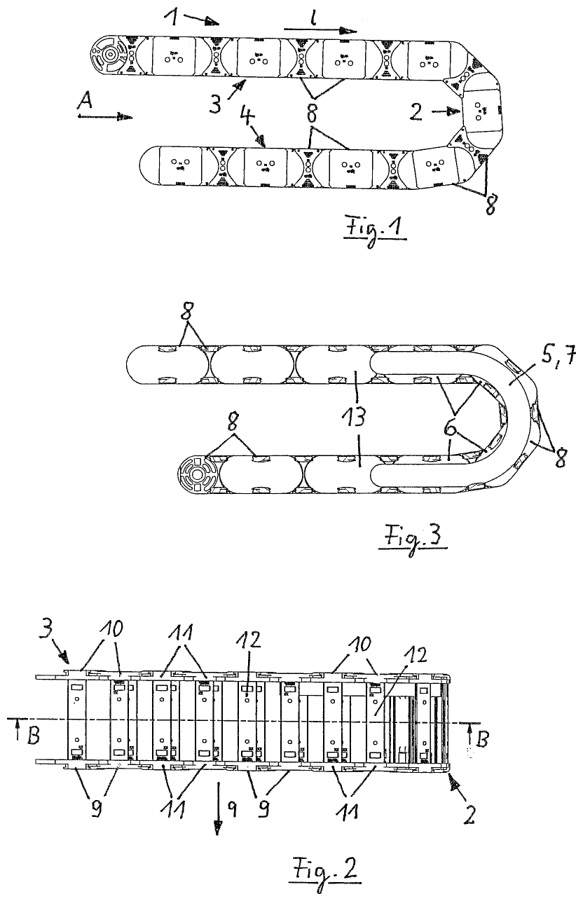

FIG. 3 a longitudinal section along line A-A in FIG. 2,

FIG. 4 a face-side view in the direction of the arrow B in FIG. 1,

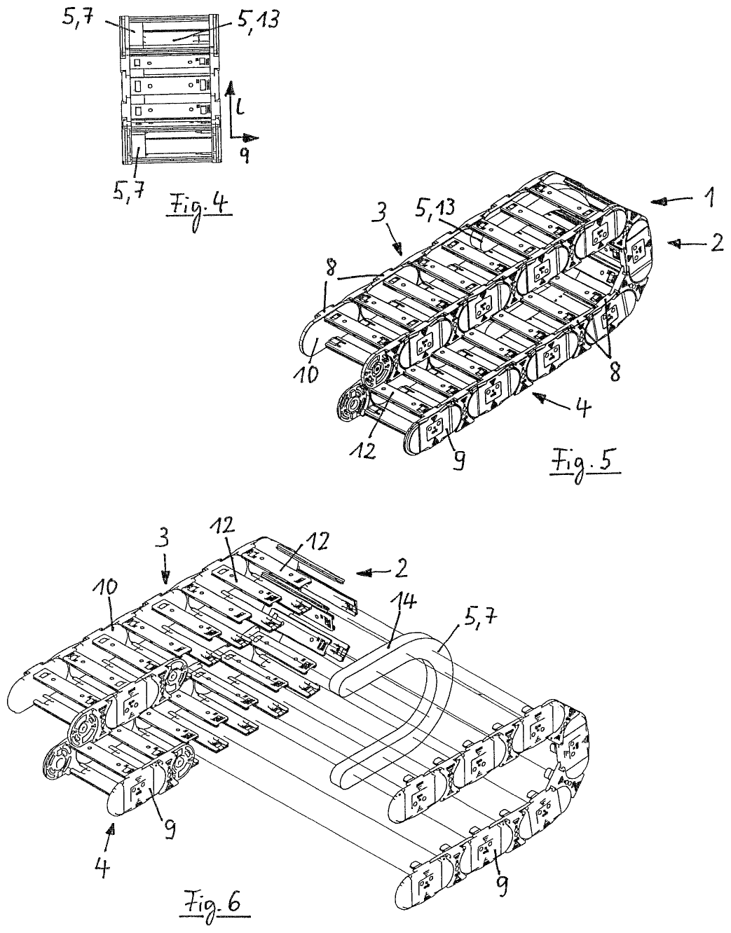

FIG. 5 a perspective view of the portion of the energy chain shown in FIG. 1,

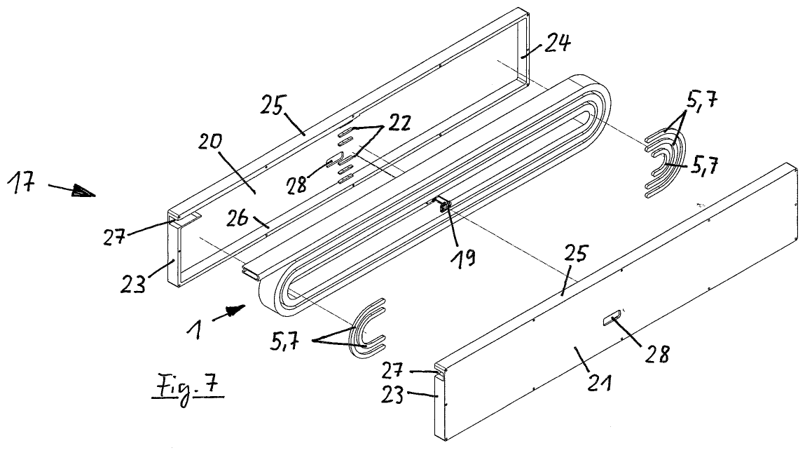

FIG. 6 an exploded perspective view according to FIG. 5 to represent the insertion of the stabilization element in the deflection region,

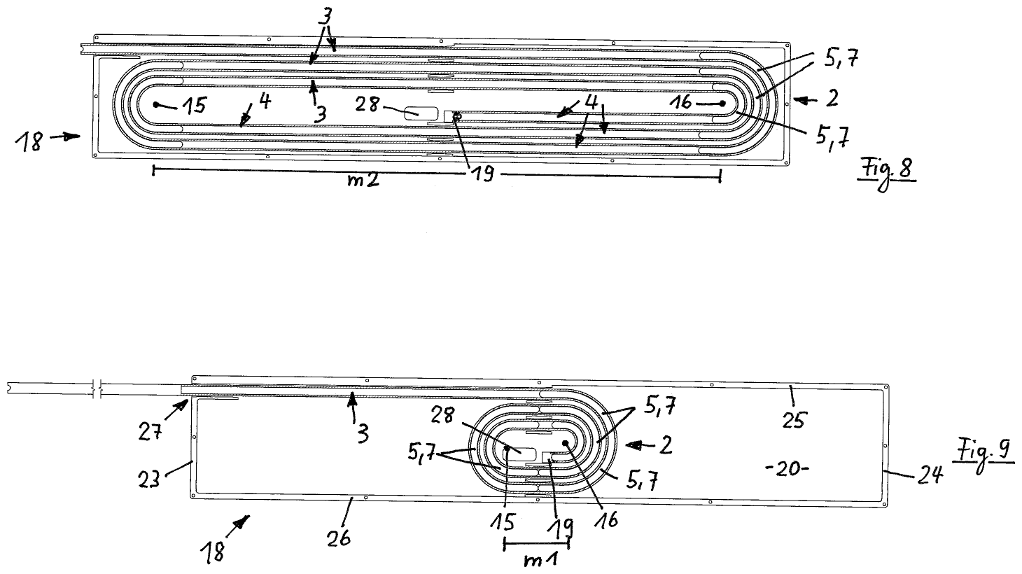

FIG. 7 an exploded perspective representation of a storage unit for receiving a spirally wound energy chain consisting of several portions according to FIG. 1,

FIG. 8 a side view of the energy chain maximally retracted into the storage housing with maximum spacing of the winding axes, and

FIG. 9 a side view of the energy chain maximally extended out of the storage housing with minimum spacing of the winding axes.

As follows from FIGS. 1-6 of the drawing, a cable guide 1, formed here as an energy chain, is arranged in a first portion in the form of two first and second strands 3, 4, which are connected to one another by a deflection region 2 extending about a deflection arc, wherein the cable guide 1 is movable about the deflection arc of the deflection region 2.

To stabilize the deflection region during its running which is as frictionless as possible, a stabilization element 5, which is substantially adapted to the deflection arc of the deflection region 2, is arranged in a guide space 6 of the deflection region 2 extending along the first portion of the cable guide 1 and passing through this in at least one region, which stabilization element supports the deflection region 2 in the guide space 6 in a floating manner during movement of the cable guide 1 about the deflection arc, without emerging from it.

The first portion of the cable guide 1, formed here as part of an energy chain, has chain links 8 which adjoin one another, as usual, in the longitudinal direction (l) and which comprise in each case two side parts 9, 10 lying opposite one another in a transverse direction q relative to the longitudinal direction I. The side parts 9, 10 have narrow surfaces 11, which in each case face perpendicularly to the transverse direction q and to the longitudinal direction I and face inwards and outwards in the deflection region 2. At least some of the chain links 8 have cross members 12 connecting their side parts 9, 10.

The cross members 12 are connected to the side parts 9, 10 in the region of the narrow surfaces 11.

The energy chain forming the first portion of the cable guide 1 is furthermore formed such that adjacent chain links 8 are capable of being angled in one pivoting direction to a limited degree relative to one another due to limit stops and thereby define the minimum radius of the deflection arc of the deflection region 2 of the energy chain. In the other pivoting direction, adjacent chain links 8 are capable of being angled to a limited degree up to their orientation stretched out relative to one another. A relatively stable straight extension of the strands 3 and 4 as self-supporting strands is made possible thereby.

As follows from FIGS. 1-6 of the drawing, the bar 7 chosen as stabilization element 5 in the embodiment example under consideration is arranged in the receiving space 13 of the energy chain, with the result that it encloses the guide space 6 for the bar 7. As shown in particular in FIGS. 2 and 5, the bar 7 is arranged laterally adjacent to one side of the side parts 10 of the chain links 8 adjoining one another in the longitudinal direction I, and extends in the deflection region 2 with its outer face 14 along the cross members 12 arranged radially outwards in relation to the deflection region 2. The bar 7 is arranged in a floating manner in this region of the receiving space 13 of the energy chain, i.e., it can move together with the deflection region 2 in a floating manner in the longitudinal direction I of the strands 3, 4 during movement of the energy chain.

As follows in particular from FIG. 3, the curved bar 7 extends about the entire arc of the deflection region 2 into the respectively first chain links 8 of the adjoining strands 3, 4.

The energy chain is to be opened at least on one of its sides in the region of a possible position of the deflection region, with the result that the side plates 9 arranged on this side in this region are removable from the cross members 12, as represented in FIG. 6. By detachment of the side parts 9 in the region in question of the deflection arc of the deflection region 2 and the chain links 8 of the adjoining strands 3, 4, the arc-shaped bar 7 can be inserted laterally in the receiving space 13 and in the guide space 6 provided therein for the bar 7, whereupon the opened side region of the energy chain can be closed again by reattachment of the strand comprising the side parts 9.

As shown in FIGS. 7-9, the cable guide 1, formed, e.g., as an energy chain, can be arranged in the shape of a spiral with two winding axes 15, 16 spaced apart from one another, wherein the spiral is formed of several portions of the type described with reference to FIGS. 1-6 with a deflection region 2 and adjoining strands 3, 4. A stabilization element 5 in the form of an above-described arc-shaped bar 7 is arranged in each deflection region 2. Several deflection regions 2 of the cable guide 1 extend in each case about the winding axes 15, 16.

In the embodiment example shown in FIGS. 7-9, the spiral winding of the cable guide 1 serves to store the cable guide 1 in a storage unit 17, which further has a storage housing 18. The cable guide 1 has a fixed connection point 19 arranged stationarily in the storage housing 18 in the interior of the spiral at one of its ends and a movable connection point (not represented in the drawing), which is arranged outside the storage housing 18, at its other end. The fixed connection point 19 is arranged, as follows from FIGS. 8 and 9, in the region of the free end of the inner winding of the cable guide 1 with the deflection region 2 having the smallest radius, while the movable connection point is located at the free end of the outer winding with the deflection region 2 having the largest radius.

When the movable connection point moves, the cable guide 1 can be moved such that the spacing of the winding axes 15, 16 is variable between the maximum spacing m2 shown in FIG. 8 and the minimum spacing m1 shown in FIG. 9. The length of the cable guide 1 stored in the storage housing 18 then corresponds to the difference between the maximum spacing m2 and the minimum spacing m1 multiplied by the number of strands connected to the deflection regions 2 lying opposite one another, including the strand protruding from the storage housing 18 to the movable connection point, if, as in the embodiment example under consideration, the fixed connection point 19 is located in the central region of the storage housing 18 relative to its longitudinal extension.

The storage housing 18 has two parallel side plates 20, 21, which are arranged parallel to the deflection arcs of the deflection regions 2 of the cable guide 1 and guide the deflection regions 2 and strands 3, 4 of the cable guide 1 laterally, where appropriate with a small clearance. The side plates 20, 21 extend in the longitudinal direction I of the strands 3, 4 over the deflection regions 2 of the cable guide 1 on both winding axes 15, 16.

In the central region relative to the longitudinal extension of the side plates 20, 21, guide projections 22 are provided on their inwardly facing faces to support and guide the strands 3, 4 of the cable guide 1 in the storage housing 18. Such a support and guiding of the strands 3, 4 can be necessary in order to prevent the strands from sagging during movement of the cable guide 1 from the extended position represented in FIG. 9 into the retracted position shown in FIG. 8 and during the movement in reverse. A pretensioning of the winding axes 15, 16 in their position represented in FIG. 8 with the maximum spacing m2 is not necessary. It would in turn necessitate a support of the deflection regions 2 of the cable guide 1 extending about the winding axes 15, 16, which would be associated with friction losses.

In the embodiment example shown in FIGS. 7-9 it is possible, on the other hand, to pull the spirally wound cable guide 1 out of the storage housing 18 with relatively little tensile force on the strand connected to the movable connection point and to insert it in the storage housing 18 with relatively little compressive force on the strand connected to the movable connection point in its longitudinal direction.

At the face-side ends of the side plates 20, 21 the storage housing 18 is, as follows from FIG. 7, provided with face plates 23, 24 and upper and lower closing plates 25, 26 connecting these to one another. The face plate 23 facing towards the movable connection point has a feed-through opening 27 in its upper region for the strand 3 of the cable guide 1 connected to the movable connection point.

### LIST OF REFERENCE NUMBERS

1 Cable guide
2 Deflection region
3 Strand
4 Strand
5 Stabilization element
6 Guide space
7 Bar
8 Chain link
9 Side part
10 Side part
11 Narrow surface
12 Cross member
13 Receiving space
14 Outer face
15 Winding axis
16 Winding axis
17 Storage unit
18 Storage housing
19 Fixed connection point
20 Side plate
21 Side plate
22 Guide projection
23 Face plate
24 Face plate
25 Closing plate
26 Closing plate
27 Feed-through opening
28 Opening
q Transverse direction
l Longitudinal direction
m1 Minimum spacing
m2 Maximum spacing

1. A cable guide (1) for receiving energy or communication cables in a receiving space (13), the cable guide comprising:
a first portion having two first and second strands (3, 4) connected to one another by a deflection region (2) extending about a deflection arc, wherein the cable guide (1) can be moved about the deflection arc of the deflection region (2), and
a stabilization element (5), which is substantially adapted to the deflection arc of the deflection region (2), arranged in a guide space (6) of the deflection region (2) extending along the first portion of the cable guide and passing through the cable guide in at least one region, which stabilization element, during movement of the cable guide (1) about the deflection arc, supports the deflection region (2) in a floating manner in the guide space (6) without emerging from the guide space.

2. The cable guide (1) according to claim 1, wherein the stabilization element (5) extends in the guide space (6) along the entire deflection region (2) in each case.

3. The cable guide (1) according to claim 1, wherein the stabilization element (5) extends over the deflection region (2) and partially into a region of the guide space (6) of the first and/or second strand (3, 4) adjoining the deflection region (2).

4. The cable guide (1) according to claim 1, wherein the guide space (6) for the stabilization element (5) is formed by a partial region, extending along the cable guide (1), of the receiving space (13) for the cables.

5. The cable guide (1) according to claim 1, wherein the stabilization element (5) is formed as an arc-shaped bar (7) adapted to the deflection arc of the deflection region (2).

6. The cable guide (1) according to claim 5, wherein the arc-shaped bar (7) is formed disc-shaped, wherein the arc-shaped bar extends with a relatively small extent perpendicular to a plane in which the deflection arc of the deflection region (2) runs and with a relatively large extent along a arc-shaped progression of the arc-shaped bar in this plane.

7. The cable guide (1) according to claim 5, wherein the arc-shaped bar (7) extends along its larger extent in the guide space (6) with a relatively small clearance.

8. The cable guide (1) according to claim 1, wherein the cable guide is configured, at least in its first portion, as an energy chain having chain links (8) adjoining one another pivotably in the longitudinal direction (l), wherein the chain links (8) include in each case two side parts (9, 10), which lie opposite one another in a transverse direction (q) relative to the longitudinal direction (l) and have narrow surfaces (11) facing perpendicularly to the transverse direction (q) and to the longitudinal direction (l) and facing inwards and outwards in the deflection region (2), wherein at least some chain links (8) include cross members (12) connecting their side parts (9, 10).

9. The cable guide (1) according to claim 8, wherein the stabilization element (5) is arranged in a floating manner in the deflection region (2) between the cross members (12) in the receiving space (13) and extending between the side parts (9, 10) and the cross members (12), for the cables.

10. The cable guide (1) according to claim 9, wherein the stabilization element (5) is arranged in a lateral region of the receiving space (13) adjacent to the side parts (9) adjoining one another in the longitudinal direction (l) on one side of the energy chain.

11. The cable guide (1) according to claim 8, wherein adjacent chain links (8) of the energy chain are capable of being angled in one pivoting direction to a limited degree relative to one another due to limit stops and in another pivoting direction are capable of being angled to a limited degree up to their orientation stretched out relative to one another.

12. The cable guide (1) according to claim 1, further comprising several portions in the manner of the first portion, wherein in the deflection region (2) of each portion a substantially rigid stabilization element (5), which is adapted to the deflection arc of the deflection region (2), is arranged in a guide space of the deflection region (2) extending along the portion and passing through it in at least one region, which stabilization element, during movement of the cable guide (1) about the deflection arc, supports the deflection region (2) in a floating manner in the guide space (6) without emerging from the guide space.

13. The cable guide (1) according to claim 12, wherein the cable guide is formed in the form of a continuous loop with two deflection regions (2) lying opposite one another or has several continuous loops arranged inside one another with in each case two deflection regions (2) lying opposite one another, wherein the axes of the deflection arcs of the deflection regions (2) lying opposite one another in each case are arranged with a spacing from one another.

14. The cable guide (1) according to claim 12, wherein the cable guide is arranged wound in the shape of a spiral with two winding axes (15, 16) spaced apart from one another, wherein the deflection arcs of the deflection regions (2) of the cable guide (1) extend about the winding axes (15, 16).

15. A storage unit (17) for a cable guide, the storage unit comprises a storage housing (18) and a cable guide (1), which is arranged therein and spirally wound, according to claim 14, wherein the cable guide (1) has a fixed connection point (19) arranged stationarily in the storage housing (18) in the interior of the spiral at one of its ends and a movable connection point at its other end, wherein, by movement of the movable connection point and movement caused thereby of the cable guide (1), the spacing between the winding axes (15, 16) is variable between a minimum spacing (m1) and a maximum spacing (m2).

16. The storage unit (17) according to claim 15, wherein no pretensioning causing a variation of the spacing of the two winding axes (15, 16) towards their maximum spacing (m2) is provided between the deflection regions (2) extending about one of the two winding axes (15, 16) on the one hand and the deflection regions (2) of the cable guide (1) extending about the other of the two winding axes (15, 16).

17. The storage unit (17) according to claim 15, wherein the fixed connection point (19) is arranged in a central region relative to an extension of the storage housing (18) in the longitudinal direction (l) of the strands (3, 4) of the cable guide (1).

18. The storage unit (17) according to claim 17, wherein in the central region of the storage housing relative to its extension in the longitudinal direction (l) of the strands (3, 4) of the cable guide (1), guide elements are provided to support and guide the strands (3, 4) of the cable guide (1) in the storage housing (18).

19. The storage unit (17) according to claim 15, wherein the storage housing (18) includes two parallel side plates (20, 21), which are arranged parallel to the deflection arcs of the deflection regions (2) of the cable guide (1) and guide the deflection regions (2) and strands (3, 4) of the cable guide (1) laterally in a sliding manner, wherein the side plates (20, 21) extend in the longitudinal direction of the strands (3, 4) over the deflection regions (2) of the cable guide (1) on both winding axes (15, 16).

20. The storage unit (17) according to claim 19, wherein in a central region of the side plates (20, 21) relative to their extension in the longitudinal direction (l) of the strands, guide projections (22) are provided on their inwardly facing surfaces to support and guide the strands (3, 4) of the cable guide (1) in the storage housing (18).

21. The storage unit (17) according to claim 19, wherein at the face-side ends of the side plates (20, 21) the storage housing (18) has face plates (23, 24) and upper and lower closing plates (25, 26) connecting these to one another.

22. The storage unit (17) according to claim 21, wherein one of the face plates (23, 24) has a feed-through opening (27) in the upper or lower region for the strand of the cable guide (1) connected to the movable connection point.

23. The storage unit (17) according to claim 19, wherein in at least one of the side plates (20, 21) in the region of the fixed connection point (19) has an opening (28) for guiding the cables emerging from the cable guide (1) out of the storage housing (18).
